(19) United States
(12) Patent Application Publication
(10) Pub. No.: US 2016/0237972 A1
(43) Pub. Date: Aug. 18, 2016

(54) FUEL INJECTION APPARATUS

(71) Applicant: TOYOTA JIDOSHA KABUSHIKI KAISHA, Toyota-shi (JP)

(72) Inventor: Jun KAWAKAMI, Susono-shi (JP)

(73) Assignee: TOYOTA JIDOSHA KABUSHIKI KAISHA, Toyota-shi (JP)

(21) Appl. No.: 15/045,541

(22) Filed: Feb. 17, 2016

(30) Foreign Application Priority Data
Feb. 18, 2015 (JP) 2015-029805

(51) Int. Cl. F02M 61/18

(52) U.S. Cl. CPC F02M 61/1806

(57) ABSTRACT

A combustion state is improved in a fuel injection valve having a plurality of nozzle holes adapted to be closed with a time difference. A fuel injection valve is provided which has a total nozzle hole area which becomes larger when an operation amount of a needle is large than when it is small, wherein when the total nozzle hole area is changed from a large state to a small state, the pressure of fuel is increased in such a manner that the pressure of fuel becomes larger when the total nozzle hole area is in the small state than when it is in the large state.

### CROSS REFERENCE TO RELATED APPLICATIONS

This application claims priority to Japanese Patent Application No. 2015-029805 filed on Feb. 18, 2015, the entire contents of which are incorporated by reference herein.

### BACKGROUND OF THE INVENTION

1. Field of the Invention

The present invention relates to a fuel injection apparatus.

2. Description of the Related Art

There has been known a fuel injection valve which is provided with an outer needle for opening and closing first nozzle holes, and an inner needle for opening and closing second nozzle holes, wherein the valve is further provided with a mechanism in which when and after the outer needle rises a predetermined amount, the inner needle rises with the outer needle (for example, refer to a first patent literature).

In a general fuel injection valve having an outer needle and an inner needle, the outer needle first rises so that fuel is injected from first nozzle holes, and then, when and after the outer needle rises a predetermined amount, the inner needle is caused to rise by means of the outer needle pushing the inner needle. As the inner needle rises, fuel is injected from the first nozzle holes and second nozzle holes. After that, as the outer needle drops, the inner needle also drops, similarly. When the outer needle and the inner needle drop and an amount of lift of the outer needle becomes a predetermined amount, the inner needle is seated down, so that the fuel injection from the second nozzle holes is terminated, and fuel is injected only from the first nozzle holes. Finally, the outer needle is seated down and the injection of fuel from the first nozzle holes is terminated.

### CITATION LIST

### Patent Literature

First Patent Literature: Japanese patent laid-open publication No. 2006-161678

Second Patent Document: Japanese patent application laid-open No. 2007-016773

### SUMMARY OF THE INVENTION

### Technical Problem

In the fuel injection valve having the above-mentioned mechanism, after the seating of the inner needle and before the termination of the fuel injection, there is a period of time in which fuel is injected only from the first nozzle holes. In this period of time, the amount of fuel injection per unit time (i.e., injection rate) becomes small, as compared with the time in which fuel is injected from the first nozzle holes and the second nozzle holes. Here, in a fuel injection valve having only one needle, the injection rate decreases only in a relatively short period of time immediately before the seating of the needle. On the other hand, in the fuel injection valve having the above-mentioned outer needle and inner needle, the injection rate decreases in a period of time from immediately before the seating of the inner needle until the seating of the outer needle. For this reason, a long period of time is required to complete the injection of fuel. Here, when the period of time of fuel injection becomes long, fuel will come to be injected into a cylinder in which the fuel injected in an early stage of the fuel injection has burned or combusted and become high temperature and high pressure, at the end of the fuel injection, as a result of which combustion will start in a state where the mixing of fuel and air injected is insufficient, so a smoke will become easy to occur.

The present invention has been made in view of the problem as referred to above, and the object thereof is to improve a combustion state in a fuel injection valve which has a plurality of nozzle holes adapted to be closed with a time difference.

### Solution to Problem

In order to solve the aforementioned problem, a fuel injection apparatus according to the present invention is provided with: a fuel injection valve that has a total nozzle hole area which becomes larger when an operation amount of a needle is large than when it is small; and a controller that increases the pressure of fuel, upon a change of said total nozzle hole area from a large state to a small state, in such a manner that the pressure of fuel becomes larger when said total nozzle hole area is in the small state than when it is in the large state.

The injection rate of fuel may be decreased by the changing of the total nozzle hole area from the large state to the small state, but it is possible to suppress the injection rate from being actually decreased, by increasing the pressure of fuel to be injected at this time. That is, it is possible to maintain the state where the injection rate is high. As a result, the time or timing at which, the needle is dropped can be made early, without changing the total amount of the amount of fuel injection, so that the period of time of fuel injection can be shortened. For this reason, the generation of smoke can be suppressed. In addition, the atomization of fuel can also be promoted due to an increase in the pressure of the fuel, and hence the combustion thereof can be promoted, by which, too, the generation of smoke can be suppressed.

In addition, in the fuel injection apparatus in which said fuel injection valve has a first nozzle hole, a second nozzle hole, a first needle for opening and closing said first nozzle hole, and a second needle for opening and closing said second nozzle hole, said second needle being operable to lift with said first needle when an amount of lift of said first needle is equal to or more than a first predetermined amount, provision is further made for a pressure changer that changes the pressure of fuel to be injected from said fuel injection valve, wherein said controller begins to increase the pressure of fuel by means of said pressure changer, when said first needle and said second needle drop so that the amount of lift of said second needle becomes a second predetermined amount, after the amount of lift of said first needle becomes equal to or more than said first predetermined amount.

It is possible to suppress the injection rate from being actually decreased, by increasing the pressure of fuel to be injected from the time or timing at which the injection rate of fuel to be injected from the second nozzle hole begins to decrease. That is, it is possible to maintain the state where the injection rate is high. As a result, the times or timings at which the first needle and the second needle are caused to drop, respectively, can be made early, without changing the total amount of the amount of fuel injection, so that the period of time of fuel injection can be shortened. For this reason, the generation of smoke can be suppressed. In addition, the atomization of fuel can also be promoted due to an increase in the pressure of the fuel, and hence the combustion thereof can be promoted, by which, too, the generation of smoke can be suppressed. The first predetermined amount is an amount of lift of the first needle at the time when the second needle begins to rise. When the amount of lift of the first needle is equal to or more than the first predetermined amount, fuel is injected from the first nozzle hole and the second nozzle hole, whereas when the amount of lift of the first needle is less than the first predetermined amount, fuel is injected only from the first nozzle hole.

Moreover, said second predetermined amount may be an amount of lift at which the injection rate of fuel to be injected from said second nozzle hole decreases, if the pressure of fuel is not increased. The second predetermined amount can also be said to be an amount of lift of the second needle when the cross-sectional area of a passage for fuel between the second needle and a valve seat therefor becomes equal to the cross-sectional area of the second nozzle hole.

Further, said controller can increase the pressure of fuel by means of said pressure changer so as not to change a combined injection rate of fuel, which is the sum of the injection rates of said first nozzle hole and said second nozzle hole, when said first needle and said second needle drop so that the amount of lift of said second needle becomes said second predetermined amount, after the amount of lift of said first needle becomes equal to or more than said first predetermined amount.

Here, when the injection rate of fuel can be decreased by the dropping of the second needle, it is possible to suppress the decrease of the injection rate, by increasing the pressure of fuel to be injected. At this time, by adjusting the pressure of fuel so as not to change the combined injection rate of fuel of the first nozzle hole and the second nozzle hole, it is possible to suppress the fluctuation of torque from occurring before and after increasing the pressure of fuel.

### Advantageous Effects of Invention

According to the present invention, it is possible to improve a combustion state in a fuel injection valve having a plurality of nozzle holes adapted to be closed with a time difference.

Further features of the present invention will become apparent from the following description of exemplary embodiments with reference to the attached drawings.

### BRIEF DESCRIPTION OF DRAWINGS

FIG. 1 is a cross sectional view of a fuel injection valve in an embodiment of the present invention.

FIG. 2 shows the fuel injection valve in a state where fuel is injected from outer nozzle holes, and fuel is not injected from inner nozzle holes.

FIG. 3 shows the fuel injection valve in a state where fuel is injected from the outer nozzle holes and the inner nozzle holes.

FIG. 4 is a time chart showing the change over times of an injection signal, a booster unit driving signal, a pressure of increase, an amount of needle lift, and an injection rate of fuel, at the time of injection control according to this embodiment.

FIG. 5 is a flow chart showing a control flow of a booster unit according to a first embodiment of the present invention.

FIG. 6 is a view showing an operating region in which the outer nozzle holes and the inner nozzle holes are used.

FIG. 7 is a time chart for making a comparison between an injection rate at the time of fuel injection in conventional art and an injection rate at the time of fuel injection according to this embodiment.

FIG. 8 is a flow chart showing a control flow of a booster unit according to a second embodiment of the present invention.

### DESCRIPTION OF EMBODIMENTS

Hereinafter, the best modes for carrying out the present invention will be exemplarily described in detail based on preferred embodiments with reference to the attached drawings. However, the dimensions, materials, shapes, relative arrangements and so on of component parts described in the embodiments are not intended to limit the scope of the present invention to these alone in particular as long as there are no specific statements.

### First Embodiment

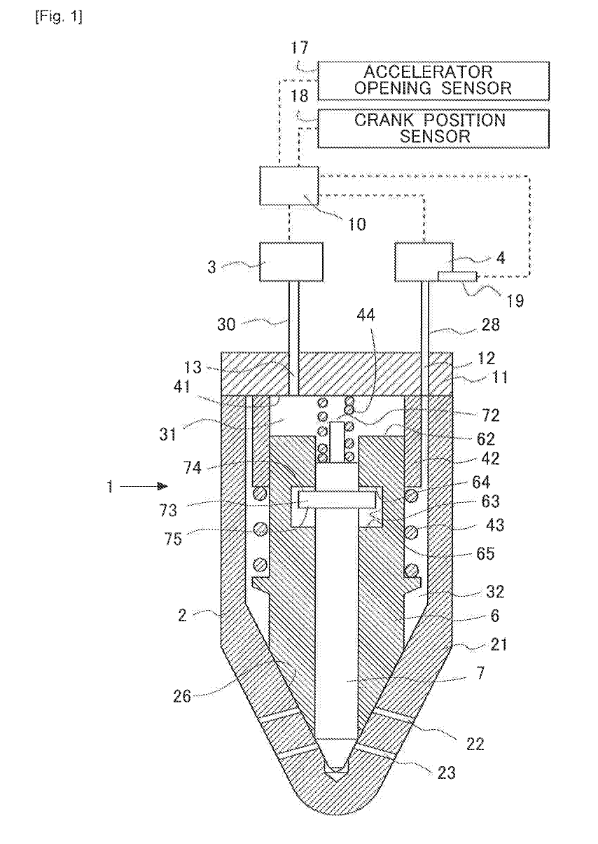

FIG. 1 is a cross sectional view of a fuel injection valve 1 in this first embodiment. The fuel injection valve 1 is applied to an internal combustion engine such as a diesel engine, for example. The fuel injection valve 1 is provided for each of cylinders of the internal combustion engine, and serves to inject fuel directly into a corresponding cylinder. Here, note that in this embodiment, in order to illustrate the fuel injection valve 1 in a simple and concise manner, a part of components thereof is omitted.

The fuel injection valve 1 is provided with a nozzle unit 2, a back pressure unit 3, and a booster unit 4. Fuel is supplied to the back pressure unit 3 and the booster unit 4 from an unillustrated common rail or the like. Then, in the back pressure unit 3 and the booster unit 4, respectively, the pressure of the fuel is adjusted by using a piezoelectric element or the like. Here, note that the back pressure unit 3 and the booster unit 4 may be arranged in the interior of the nozzle unit 2, or may be arranged in the outside of the nozzle unit 2. A pressure sensor 19 for detecting the pressure of fuel is arranged in the booster unit 4. The pressure sensor 19 detects the pressure of the fuel flowing out of the booster unit 4, and this pressure of the fuel is equal to the pressure of fuel to be injected from the fuel injection valve 1. The booster unit 4 according to this embodiment boosts the pressure of fuel at a predetermined ratio. Here, note that the structures of the back pressure unit 3 and the booster unit 4 are well-known, and so the explanation thereof is omitted. In this embodiment, the booster unit 4 corresponds to a pressure changer in the present invention.

The nozzle unit 2 is provided with a plate 11 and a nozzle body 21. The nozzle body 21 is a member of an annular cylindrical shape in which one end thereof at the side of the plate 11 is opened, and the other end thereof is closed, wherein an outer needle 6, an inner needle 7, a cylinder 42, an outer spring 43 and an inner spring 44 are received in the nozzle body 21. The plate 11 is fixedly secured to a top end of the nozzle body 21 by means of unillustrated retaining nuts, etc.

In addition, outer nozzle holes 22 and inner nozzle holes 23 are formed in the bottom portion of the nozzle body 21. For the outer nozzle holes 22 and the inner nozzle holes 23, a plurality of through holes are formed in the nozzle body 21 along concentric circles of different diameters around the central axis of the nozzle body 21. The outer nozzle holes 22 are formed at a more outer side than the inner nozzle holes 23, as seen from the central axis of the nozzle body 21. Here, note that in this embodiment, the outer nozzle holes 22 correspond to a first nozzle hole in the present invention, and the inner nozzle holes 23 correspond to a second nozzle hole in the present invention.

The outer needle 6 and the inner needle 7 are valve bodies which carry out the opening and closing of the outer nozzle holes 22 and the inner nozzle holes 23 at their nozzle hole side ends, respectively. The central axes of the outer needle 6 and the inner needle 7 are coaxial with the central axis of the nozzle body 21. The outer needle 6 is an annular cylindrical valve body which has a hollow portion around the central axis thereof. The inner needle 7 is a valve body of a solid cylindrical shape which is inserted in the hollow portion of the outer needle 6 in such a manner that it is movable in the central axis direction of the outer needle 6. Here, note that in this embodiment, the outer needle 6 corresponds to a first needle in the present invention, and the inner needle 7 corresponds to a second needle in the present invention.

At the side opposite to the side of the nozzle holes 22, 23 in the axial direction of the outer needle 6 (hereinafter, referred to as an opposite nozzle hole side), there is arranged an annular cylindrical cylinder 42 which serves to guide the movement of the outer needle 6. The cylinder 42 has an opposite nozzle hole side end in abutment with a wall surface 41 of the plate 11. The outer spring 43 for urging the outer needle 6 in the direction of the nozzle holes is arranged between a nozzle hole side end of the cylinder 42 and the outer needle 6. The inner spring 44 for urging the inner needle 7 in the direction of the nozzle holes is arranged between the wall surface 41 of the plate 11 and the inner needle 7.

Some spaces are formed in the interior of the nozzle body 21. A nozzle chamber 32 is formed between the inner wall of the nozzle body 21 and the side wall of the outer needle 6. This nozzle chamber 32 is connected at one end thereof to one end of a fuel supply passage 28 through a passage 12 formed in the plate 11, and at the other end thereof to the outer nozzle holes 22 and the inner nozzle holes 23. The fuel supply passage 28 is connected at the other end thereof to the booster unit 4. The high pressure fuel introduced into the nozzle chamber 32 through the fuel supply passage 28 is injected from the outer nozzle holes 22 and the inner nozzle holes 23.

Moreover, a back pressure chamber 31 is defined at the opposite nozzle hole side end of the nozzle body 21 by an outer opposite nozzle hole side pressure receiving surface 62 of the outer needle 6, an inner opposite nozzle hole side pressure receiving surface 72 of the inner needle 7, the wall surface 41 of the plate 11, and the inner wall of the cylinder 42. This back pressure chamber 31 leads to one end of a fuel passage 30 through a passage 13 formed in the plate 11. This fuel passage 30 is connected at the other end thereof to the back pressure unit 3. By driving the back pressure unit 3, the pressure in the back pressure chamber 31 can be adjusted. Here, when a driving signal is inputted to the back pressure unit 3, the pressure in the back pressure chamber 31 is decreased. As a result of this, the force applied to both the opposite nozzle hole side pressure receiving surfaces 62, 72 decreases, so that the outer needle 6 is drawn near to the opposite nozzle hole side.

An annular groove 63 is formed in the inner wall of the outer needle 6. This groove 63 is formed in such a manner that an inner peripheral surface thereof becomes parallel to the direction of the central axis of the outer needle 6, and inner wall surfaces thereof at the nozzle hole side and at the opposite nozzle hole side are orthogonal to the direction of the central axis of the outer needle 6. The wall surface of this groove 63 at the opposite nozzle hole side is referred to as a groove upper end surface 64, and the wall surface thereof at the nozzle hole side is referred to as a groove lower end surface 65.

On the other hand, the inner needle 7 is formed with a protrusion 73 of a solid cylindrical shape which is coaxial with the inner needle 7 and is larger in diameter than the inner needle 7. An end face of this protrusion 73 at the opposite nozzle hole side is referred to as a protrusion upper end surface 74, and an end face thereof at the nozzle hole side is referred to as a protrusion lower end surface 75.

The groove upper end surface 64 and the protrusion upper end surface 74 are arranged in opposition to each other, and the groove lower end surface 65 and the protrusion lower end surface 75 are arranged in opposition to each other. In addition, the height of the protrusion 73, i.e., the distance between the protrusion upper end surface 74 and the protrusion lower end surface 75, is shorter than the distance from the groove upper end surface 64 to the groove lower end surface 65.

As shown in FIG. 1, in the state where both the needles 6, 7 close both the nozzle holes 22, 23, respectively, gaps are formed between the protrusion upper end surface 74 and the groove upper end surface 64 and between the protrusion lower end surface 75 and the groove lower end surface 65, respectively.

On the inner wall surface of the nozzle body 21 in the surroundings of the outer nozzle holes 22 and the inner nozzle holes 23, there is formed a valve seat 26 on which each of the outer needle 6 and the inner needle 7 is seated. FIG. 1 shows a state where the outer needle 6 and the inner needle 7 are seated, wherein the outer nozzle holes 22 are closed by the outer needle 6, and the inner nozzle holes 23 are closed by the inner needle 7.

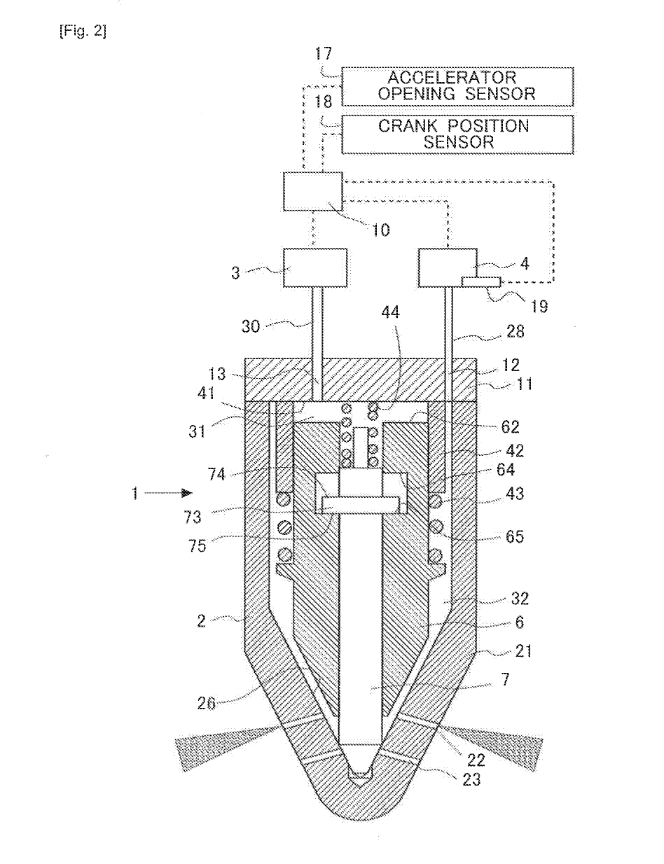

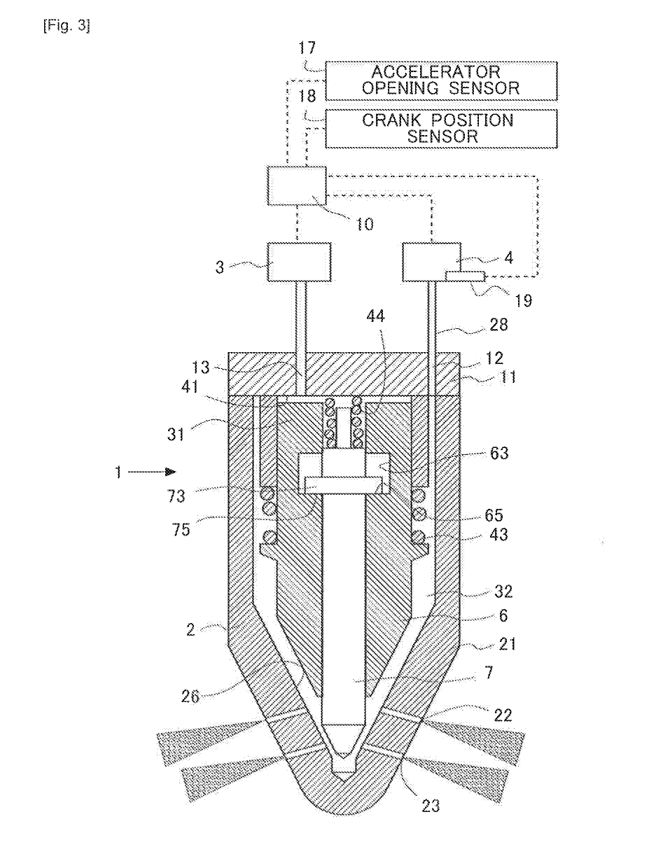

The operations of the outer needle 6 and the inner needle 7 will be explained. FIG. 2 shows the fuel injection valve 1 in a state where fuel is injected from outer nozzle holes 22, and fuel is not injected from inner nozzle holes 23. FIG. 3 shows the fuel injection valve 1 in a state where fuel is injected from the outer nozzle holes 22 and the inner nozzle holes 23.

When a driving signal is inputted to the back pressure unit 3, the pressure in the back pressure chamber 31 is decreased, so that the pressure applied to the outer opposite nozzle hole side pressure receiving surface 62 is decreased. According to this, a force acting in the direction opposite to the nozzle holes becomes large rather than a force acting in the direction to the nozzle holes, so that the outer needle 6 is caused to move in the direction opposite to the nozzle holes. As a result, the outer needle 6 is moved away from the valve seat 26, so that high pressure fuel is injected from the outer nozzle holes 22 (FIG. 2).

When the outer needle 6 is moved further in the direction opposite to the nozzle holes, the groove lower end surface 65 in the outer needle 6 abuts against the protrusion lower end surface 75. Thereafter, the inner needle 7 is moved in the direction to the wall surface 41 together with the outer needle 6. At this time, the inner needle 7 is moved away from the valve seat 26, so that high pressure fuel is injected from the inner nozzle holes 23 (FIG. 3). Accordingly, the fuel injection valve 1 according to the present invention can be said as a fuel injection valve in which a total nozzle hole area becomes larger when an operation amount of a needle is large than when it is small.

Subsequently, when the input of the driving signal to the back pressure unit 3 is terminated, the pressure in the back pressure chamber 31 becomes high, so that the pressure applied to the outer opposite nozzle hole side pressure receiving surface 62 and the inner opposite nozzle hole side pressure receiving surface 72 is increased. Accordingly, both the outer needle 6 and the inner needle 7 are moved in the direction to the nozzle holes. After that, the inner needle 7 is first seated to the valve seat 26 so that the injection of fuel from the inner nozzle holes 23 is stopped (FIG. 2), and then, the outer needle 6 is seated to the valve seat 26 so that and the injection of fuel from the outer nozzle holes 22 is stopped (FIG. 1).

In the fuel injection valve 1 constructed as mentioned above, there is arranged in combination therewith an ECU 10 which is an electronic control unit for controlling the fuel injection valve 1. This ECU 10 controls the fuel injection valve 1 in accordance with the operating conditions of the internal combustion engine and/or driver's requirements. Besides the above-mentioned sensors, an accelerator opening sensor 17, which serves to detect an engine load by outputting an electrical signal corresponding to an amount by which a driver depressed an accelerator pedal, and a crank position sensor 18, which serves to detect the rotational speed of the engine, are connected to the ECU 10 through electrical wiring, and the output signals of these variety of kinds of sensors are inputted to the ECU 10. On the other hand, the back pressure unit 3 and the booster unit 4 are connected to the ECU 10 through electrical wiring, so that these units are controlled by means of the ECU 10. Here, note that the ECU 10 controls the back pressure unit 3 and the booster unit 4 of the fuel injection valve 1, but in the following, it is assumed that the ECU 10 controls the fuel injection valve 1. The ECU 10 adjusts the pressure of fuel by operating the booster unit 4. Moreover, the ECU 10 causes the outer needle 6 and the inner needle 7 to rise and drop by operating the back pressure unit 3. Here, note that in this embodiment, the movements of the outer needle 6 and the inner needle 7 to the opposite nozzle hole side are each referred to as “rising”, and the movements thereof to the nozzle hole side is deferred to as “dropping”. In addition, an amount of movement from the seated position of each of the outer needle 6 and the inner needle 7 to the opposite nozzle hole side is referred to as an “amount of lift”.

In the fuel injection valve 1 as constructed in this manner, there is a correlation between the amount of lift of the outer needle 6 and the amount of lift of the inner needle 7, so that the amount of lift of the inner needle 7 is decided according to the amount of lift of the outer needle 6. Accordingly, the inner needle 7 can not be operated independently from the outer needle 6. For this reason, at the time of terminating fuel injection, the inner needle 7 will first be seated, and the outer needle 6 will then be seated, and hence, there is a period of time in which fuel is injected only from the outer nozzle holes 22.

Here, when the period of fuel injection becomes long, there is a fear that smoke may be generated. That is, when the period of fuel injection becomes long, near the end of the period of fuel injection, the interior of the cylinder is already in a state of high temperature and high pressure due to early combustion, so that combustion starts immediately after injecting fuel, and the fuel combusts in a state where the mixing thereof with air is insufficient, resulting in that smoke is easy to occur. From such a reason, during a period of time after the inner needle 7 has been seated until the outer needle 6 is seated, smoke tends to be easily generated.

On the other hand, in this embodiment, the pressure of fuel is caused to increase by means of the booster unit 4 so that the injection rate of fuel is suppressed from decreasing with dropping of the inner needle 7. Thus, by suppressing the decrease of the injection rate, the period of fuel injection can be shortened without changing the total amount of the amount of fuel injection, and hence, combustion in the state of insufficient mixing of air and fuel can be suppressed, thereby making it possible to suppress the generation of smoke.

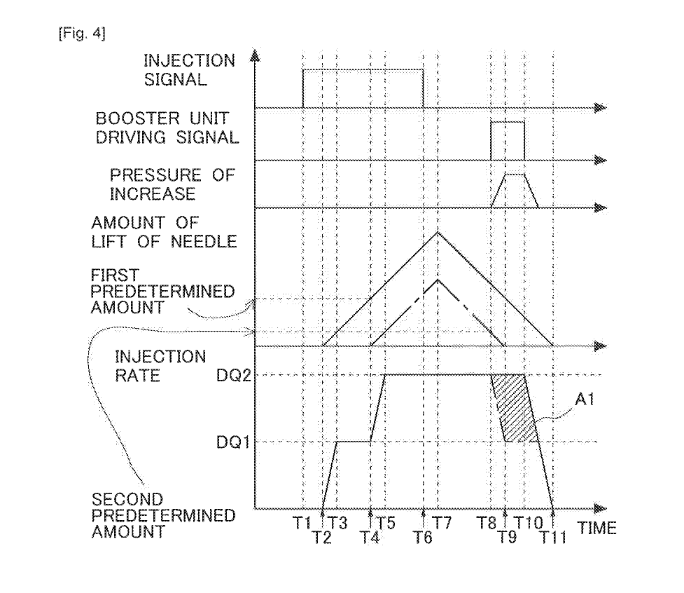

FIG. 4 is a time chart showing the change over times of an injection signal, a booster unit driving signal, a pressure of increase, an amount of needle lift, and an injection rate of fuel, at the time of injection control according to this embodiment. The injection signal is a driving signal for the back pressure unit 3, and is a signal inputted to the back pressure unit 3. When this signal is sent to the back pressure unit 3, the back pressure unit 3 decreases the pressure in the back pressure chamber 31. The booster unit driving signal is a driving signal for the booster unit 4, and when this driving signal is inputted to the booster unit 4, the booster unit 4 increases the pressure of fuel. The booster unit 4 boosts the pressure of fuel which is sent thereto from an unillustrated common rail. The pressure of increase indicates an amount of pressure increase from the pressure of fuel in the common rail. A solid line in the amount of needle lift indicates the amount of lift of the outer needle 6, and an alternate long and short dash line indicates the amount of lift of the inner needle 7. The injection rate indicates an amount of fuel injected per unit time from the outer nozzle holes 22 and the inner nozzle holes 23 in combination. Here, note that an alternate long and short dash line in the injection rate indicates a case where the back pressure unit 3 is driven in the same period of time as in this embodiment, and the increase in the pressure of fuel by the booster unit 4 is not carried out.

In FIG. 4, T1 is a starting point of the injection signal. T2 is a point in time at which the injection of fuel from the outer nozzle holes 22 is started, i.e., a point in time at which the outer needle 6 begins to rise. T3 is a point in time at which the cross-sectional area of a passage for fuel between the outer needle 6 and the valve seat 26 becomes equal to the cross-sectional area of the outer nozzle holes 22. The cross-sectional area of the outer nozzle holes 22 at this time is a value which is a total sum of all the cross-sectional areas of the plurality of the outer nozzle holes 22. T4 is a point in time at which the injection of fuel from the inner nozzle holes 23 is started, i.e., a point in time at which the inner needle 7 starts to rise. An amount of lift of the outer needle 6 at this T4 corresponds to a first predetermined amount in the present invention. T5 is a point in time at which the cross-sectional area of a passage for fuel between the inner needle 7 and the valve seat 26 becomes equal to the cross-sectional area of the inner nozzle holes 23. The cross-sectional area of the inner nozzle holes 23 at this time is a value which is a total sum of all the cross-sectional areas of the plurality of the inner nozzle holes 23.

T6 is a point in time at which the input of the injection signal is terminated. T7 is a point in time at which the outer needle 6 and the inner needle 7 start to drop. T8 is a point in time at which the cross-sectional area of a passage for fuel between the inner needle 7 and the valve seat 26 becomes equal to the cross-sectional area of the inner nozzle holes 23, and is also a point in time at which the injection rate decreases, in the case where the pressure of fuel is not boosted by the booster unit 4. In addition, T8 is a point in time at which the pressure of fuel is started to be boosted by the booster unit 4. An amount of lift of the inner needle 7 at this point in time T8 corresponds to a second predetermined amount in the present invention. T9 is a point in time at which the fuel injection from the inner nozzle holes 23 is terminated, i.e., a point in time at which the inner needle 7 is seated on the valve seat 26. T10 is a point in time at which the input of the driving signal to the booster unit 4 is terminated. T11 indicates a point in time at which the fuel injection from the outer nozzle holes 22 is terminated, i.e., a point in time at which the outer needle 6 is seated on the valve seat 26. These individual points in time T1 to T11 are decided according to the amount of fuel injection and fuel pressure.

When the injection signal is inputted to the fuel injection valve 1 from the ECU 10 at T1, the outer needle 6 starts to rise at T2. A period of time from T1 to T2 can be said as a response delay of the outer needle 6. In a period of time from T2 to T3, the injection rate increases as the amount of needle lift of the outer needle 6 increases. In a period of time from T3 to T4, the injection rate becomes constant at DQ1. At this time, the outer needle 6 continues to rise, but the injection rate is decided by the cross-sectional area of the outer nozzle holes 22, and hence, the injection rate does not increase. Then, when the amount of lift of the outer needle 6 becomes the first predetermined amount at T4, the groove lower end surface 65 and the protrusion lower end surface 75 come into abutment with each other, so that the inner needle 7 starts to rise. In a period of time from T4 to T5, the injection rate increases as the amount of needle lift of the inner needle 7 increases.

Thereafter, from T5, the injection rate becomes substantially constant at DQ2. At this time, the outer needle 6 and the inner needle 7 continue to rise, but the injection rate is decided by the cross-sectional areas of the outer nozzle holes 22 and the inner nozzle holes 23, and hence, the injection rate is substantially constant until T8.

Even when the injection signal is terminated at T6, the outer needle 6 and the inner needle 7 are each in a lifted state, and so the injection rate does not decrease immediately. Due to the termination of the injection signal, the outer needle 6 and the inner needle 7 start to drop at T7. A period of time from T6 to T7 can be said as a response delay from the termination of the injection signal until the outer needle 6 and the inner needle 7 actually start to drop. At this time, the injection rate is decided by the cross-sectional areas of the outer nozzle holes 22 and the inner nozzle holes 23, and hence, the injection rate does not decrease, though the outer needle 6 and the inner needle 7 drop.

T8 is a point in time at which the injection rate starts to decrease, if the pressure of fuel is not increased. In a period of time from T8 to T9, the inner nozzle holes 23 are open, and the cross-sectional area of the passage for fuel between the inner needle 7 and the valve seat 26 is smaller than the cross-sectional area of the inner nozzle holes 23. For this reason, the injection rate of fuel from the inner nozzle holes 23 can be changed, not with the cross-sectional area of the inner nozzle holes 23, but with the cross-sectional area of the passage for fuel between the inner needle 7 and the valve seat 26. Accordingly, after T8, the injection rate of fuel from the inner nozzle holes 23 can be decreased according to the drop of the inner needle 7, but in this embodiment, the pressure of fuel is caused to increase by driving the booster unit 4 from T8 which is a point in time at which the injection rate of fuel from the inner nozzle holes 23 starts to decrease. That is, the driving signal is inputted to the booster unit 4 from the point in time T8, so that the pressure of fuel is increased by the booster unit 4. As a result of this, the “pressure of increase”, which is an amount of increase in the pressure of fuel, gradually increases in the period of time from T8 to T9.

T9 is a point in time at which the inner needle 7 is seated on the valve seat 26. That is, at T9, the fuel injection from the inner nozzle holes 23 is terminated. The period of time from T8 to T9 is a period of time in which the pressure of fuel becomes higher according to the decrease in the cross-sectional area of the passage for fuel between the inner needle 7 and the valve seat 26, and in FIG. 4, as a result, the injection rate becomes substantially constant at DQ2. Here, note that the booster unit 4 may be constructed in such a manner that the pressure of increase rises according to the decrease of the injection rate, in the period of time from T8 to T9. That is, when the pressure of fuel increases gradually after the driving signal is inputted to the booster unit 4, the specification of the booster unit 4 may be decided so that the pressure of fuel is increased so as to compensate for the decrease of the injection rate.

In a period of time from T9 to T10, the cross-sectional area of the passage for fuel between the outer needle 6 and the valve seat 26 is larger than the cross-sectional area of the outer nozzle holes 22. For this reason, the injection rate of fuel from the outer nozzle holes 22 becomes constant. At this time, in FIG. 4, the pressure of increase is constant. Here, note that the specification of the booster unit 4 may be decided in such a manner that the pressure of increase becomes constant in the period of time from T9 to T10.

At T10, the driving signal to the booster unit 4 is stopped. Accordingly, from T10, the pressure of increase decreases. Here, T10 may be decided in such a manner that the cross-sectional area of the passage for fuel between the outer needle 6 and the valve seat 26 becomes equal to the cross-sectional area of the outer nozzle holes 22, when the pressure of increase becomes 0. Thus, in a period of time from T10 to T11, the injection rate from the outer nozzle holes 22 decreases with the decrease in the amount of lift of the outer needle 6, or the decrease in the fuel pressure. Then, at T11, the outer needle 6 is seated on the valve seat 26, whereby the fuel injection from the fuel injection valve 1 is terminated.

In the injection rate shown in FIG. 4, the amount of injection of fuel becomes larger by an area A1 of a hatched portion, in the case where the pressure of fuel is increased from T8 (in the case of the solid line) than in the case where the pressure of fuel is not increased (in the case of the alternate long and short dash line). Accordingly, in cases where the pressure of fuel is not increased as conventionally, it is necessary to input the injection signal for a longer period of time in order to inject the same amount of fuel as in the present invention. For this reason, the period of fuel injection becomes longer. On the other hand, in this embodiment, the period of fuel injection can be shortened by suppressing the decrease in the fuel injection ratio.

Here, note that in the example shown in FIG. 4, the input of the driving signal to the booster unit 4 is stopped at T10, but instead of this, the input of the driving signal to the booster unit 4 may be stopped at another time. For example, the driving signal may be input to the booster unit 4 until the point in time T11 at which the outer needle 6 is seated on the valve seat 26, or the driving signal may be input to the booster unit 4 in such a manner that the pressure of increase becomes 0 at T11. In addition, the driving signal to the booster unit 4 may be stopped at a point in time after T8 and before T10. In these cases, too, the decrease in the injection rate can be suppressed, thus making it possible to shorten the period of fuel injection.

Moreover, in this embodiment, the increase in the pressure of fuel is started from T8, but instead of this, the increase in the pressure of fuel may be started from T7 at which the inner needle 7 begins to drop. In the example shown in FIG. 4, the period of time from T7 to T8 is relatively long, but the period of time from T7 and T8 may become short, in the case where the amount of fuel injection is small, or depending on the specification of the fuel injection valve 1. In such a case, by inputting the driving signal to the booster unit 4 from T7, too, it is possible to suppress the variation of the injection rate. In addition, it is possible to simplify the control, too. Further, the increase in the pressure of fuel may be started from T9, instead of starting the increase in the pressure of fuel from T8. The pressure of fuel should only become larger, in the case when fuel is injected only from the outer nozzle holes 22, than in the case when fuel is injected from the outer nozzle holes 22 and the inner nozzle holes 23. That is, it is only necessary to increase the pressure of fuel, upon a change of the total nozzle hole area from a large state to a small state, in such a manner that the pressure of fuel becomes larger when the total nozzle hole area is in the small state than when it is in the large state. By doing in this manner, it is possible to shorten the period of fuel injection.

In addition, the point in time of T8 has a correlation with the pressure of fuel and the amount of fuel injection, and can be estimated in advance with the use of these values, so that the driving signal can be inputted to the booster unit 4, before the injection rate actually decreases. On the other hand, because the pressure of fuel is increased due to the decrease in the injection rate, the driving signal may be inputted to the booster unit 4 at the time when this increase in the pressure of fuel is detected by the pressure sensor 19.

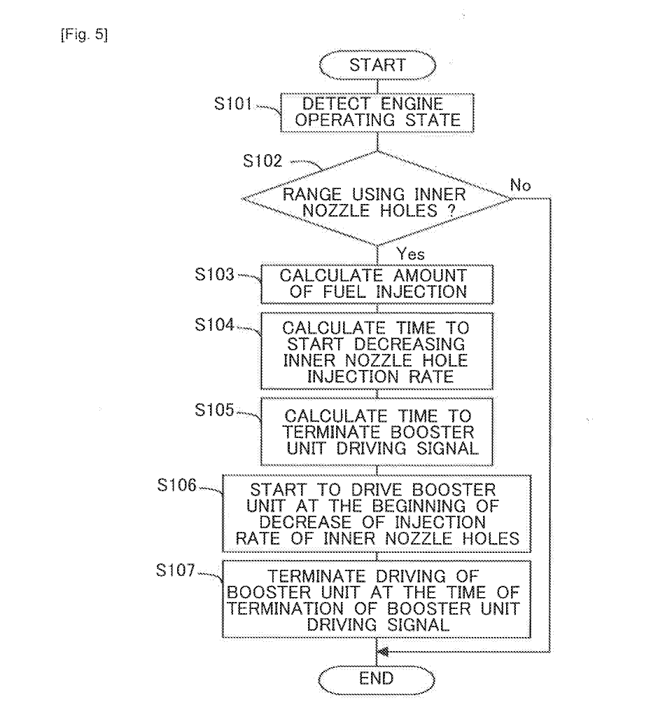

FIG. 5 is a flow chart showing a control flow or routine of the booster unit 4 according to this embodiment. The routine in this flow chart is carried out by means of the ECU 10 at each combustion cycle. Here, note that the control of the outer needle 6 and the inner needle 7 is separately carried out by the ECU 10. In addition, this flow chart is started from before fuel injection. In this embodiment, the ECU 10, which carries out the routine in the flow chart shown in FIG. 5, corresponds to a controller in the present invention.

In step S101, the operating state of the internal combustion engine is detected. Here, the engine load and the engine rotation speed are detected. In this step, a physical quantity, which is in correlation with the amount of fuel injection, is detected.

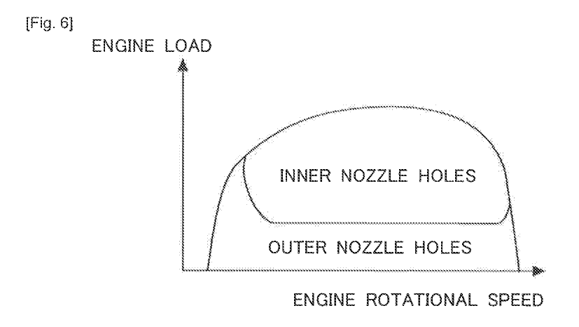

In step S102, it is determined whether an operating region of the internal combustion engine is a region in which the inner nozzle holes 23 are used. FIG. 6 is a view showing an operating region in which the outer nozzle holes 22 and the inner nozzle holes 23 are used. In FIG. 6, the axis of abscissa represents the engine rotational speed, and the axis of ordinate represents the engine load. A region indicated by “outer nozzle holes” in FIG. 6 is a region in which only the outer nozzle holes 22 are used, and a region indicated by “inner nozzle holes” is a region in which the outer nozzle holes 22 and the inner nozzle holes 23 are used. The relation of FIG. 6 has been obtained in advance by experiments, simulations or the like, and stored in the ECU 10. The inner nozzle holes 23 are used in an operating region in which the amount of fuel injection is relatively large. The ECU 10 determines, from the relation shown in FIG. 6 based on the operating state detected in step S101, whether the operating region of the internal combustion engine is a region in which the outer nozzle holes 22 are used. In cases where an affirmative determination is made in step S102, the routine goes to step S103, whereas in cases where a negative determination is made, this routine is ended.

In step S103, the amount of fuel injection is calculated. The amount of fuel injection is calculated based on the operating state of the internal combustion engine detected in step S101. This amount of fuel injection is a total amount of fuel injected in one cycle in each cylinder. The relation between the operating state of the internal combustion engine and the amount of fuel injection may have been obtained by experiments, simulations, or the like in advance, and may have been mapped.

In step S104, based on the amount of fuel injection calculated in step S103, the time at which the injection rate begins to decrease in the case where the pressure of fuel is not boosted by the booster unit 4. In this step, the time or timing to start the input of the driving signal to the booster unit 4 is obtained. That is, in this step, the above-mentioned point in time T8 is obtained. Because the amount of fuel injection and the above-mentioned point in time T8 have a correlation with each other, this correlation has been obtained and stored in the ECU 10 in advance. Here, there is also a correlation between the amount of fuel injection and a period of time in which the injection signal is inputted. Then, if the period of time in which the injection signal is inputted is decided, the changes over time of the amounts of lift of the outer needle 6 and the inner needle 7 from the start of input of the injection signal will also be decided. Accordingly, there is also a correlation between the amount of fuel injection and a period of time from the start of input of the injection signal to the above-mentioned point in time T8. For this reason, the time at which the amount of lift of the inner needle 7 becomes the second predetermined amount can be obtained according to the amount of fuel injection. Here, note that the amount of fuel injection is set based on the operating state of the internal combustion engine, and hence, in cases where the pressure of fuel is not boosted by the booster unit 4, the time at which the injection rate begins to decrease can also be calculated based on the operating state of the internal combustion engine. In addition, on the assumption that the pressure of fuel is boosted by the booster unit 4, the amount of fuel injection, the input start time of the injection signal and the input period of time of the injection signal have been obtained in association with the operating state of the internal combustion engine by experiments, simulations, or the like in advance, and have been stored in the ECU 10. Moreover, the time at which the injection rate begins to decrease in the case where the pressure of fuel is not boosted by the booster unit 4 may have been obtained and stored in the ECU 10 by experiments, simulations, or the like in advance, in association with the operating state of the internal combustion engine.

In step S105, the time or timing to terminate the input of the driving signal to the booster unit 4 is calculated. For example, the time or timing to terminate the input of the driving signal to the booster unit 4 may be decided in such a manner that the cross-sectional area of the passage for fuel between the outer needle 6 and the valve seat 26 becomes equal to the cross-sectional area of the outer nozzle holes 22, when the pressure of increase becomes 0. In place of this, the point in time at which the outer needle 6 is seated on the valve seat 26 may be used as the time or timing to terminate the input of the driving signal to the booster unit 4, or the time or timing to terminate the input of the driving signal to the booster unit 4 may be decided in such a manner that the pressure of increase becomes 0 at the point in time at which the outer needle 6 is seated on the valve seat 26. Moreover, an optimum time or timing to terminate the input of the driving signal to the booster unit 4 may have been obtained by experiments, simulations, or the like in advance, in association with the operating state of the internal combustion engine. The relation between the amount of fuel injection and the time to terminate the input of the driving signal to the booster unit 4 may have been mapped and stored in the ECU 10.

In step S106, the driving signal is inputted to the booster unit 4, after waiting until the time or timing calculated in step S104. That is, the driving of the booster unit 4 is started at the time or timing (T8) at which the injection rate begins to decrease in the case where the pressure of fuel is not boosted by the booster unit 4. This time or timing (T8) can be learned by counting or measuring a period of time elapsed from the starting point in time of the input of the injection signal, for example, by means of a timer.

In step S107, the input of the driving signal to the booster unit 4 is terminated, after waiting until the time calculated in step S105. The time or timing to terminate the input of the driving signal to the booster unit 4 can be learned by counting or measuring a period of time elapsed from the starting point in time of the input of the injection signal, for example, by means of a timer.

Here, note that in the flow chart shown in FIG. 5, the input starting time and the input termination time of the driving signal to the booster unit 4 are calculated for each cycle, but instead of this, it may be calculated for each of a plurality of cycles. In addition, the input starting time and the input termination time of the driving signal to the booster unit 4 may be calculated by using an average value of the amount of fuel injection in a plurality of past cycles.

In addition, in the flow chart shown in FIG. 5, in step S104, the time at which the injection rate begins to decrease in the case where the pressure of fuel is not boosted by the booster unit 4, but instead of this, a sensor for detecting the amount of lift of the inner needle 7 may be provided, wherein when the amount of lift detected by the sensor reaches the second predetermined amount, the boosting of the pressure of fuel by the booster unit 4 may be started. In addition, because it can be also learned based on the detected value of the pressure sensor 19 that the amount of lift of the inner needle 7 has reached the second predetermined amount, the boosting of the pressure of fuel by the booster unit 4 may be started based on the detected value of the pressure sensor 19.

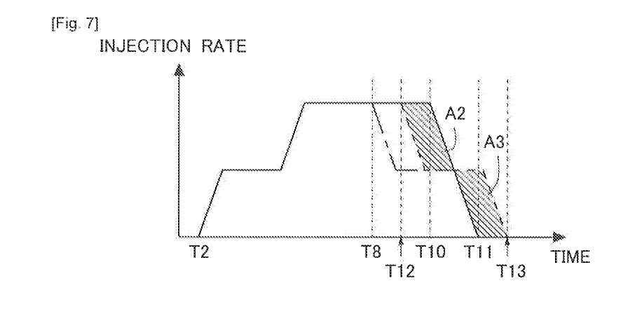

In this manner, it is possible to suppress the injection rate of fuel from being decreased, by increasing the pressure of fuel in accordance with the time at which the injection rate of fuel to be injected from the inner nozzle holes 23 begins to decrease. Here, FIG. 7 is a time chart for making a comparison between an injection rate at the time of conventional fuel injection and an injection rate at the time of fuel injection according to this embodiment. A solid line indicates the injection rate according to this embodiment, and a broken line indicates the conventional injection rate. In addition, an alternate long and short dash line indicates a case where the back pressure unit 3 is driven in the same period of time as in this embodiment, and the increase in the pressure of fuel by the booster unit 4 is not carried out. Points in time T2, T8, T10 and T11 in FIG. 7 are the same as in FIG. 4. The area of a hatched portion A2 and the area of a hatched portion A3 are equal to each other. Accordingly, FIG. 7 shows the case where the amount of fuel injection according to this embodiment and the amount of fuel injection according to the conventional art are equal to each other.

In the conventional art, at a point in time indicated by T12, the injection rate of fuel from the inner nozzle holes 23 begins to decrease. In the conventional art, the boosting of the pressure of fuel is not carried out, and hence, when the injection rate of the inner nozzle holes 23 decreases from T12, the injection rate of the fuel injection valve 1 as a whole also decreases. Then, at a point in time indicated by T13, the outer nozzle holes 22 are closed and the injection rate becomes zero. On the other hand, in this embodiment, the input period of time of the injection signal is made shorter than in the conventional art, so that the outer needle 6 and the inner needle 7 begin to drop earlier than in the conventional art. For this reason, at the point in time indicated by T8, the injection rate of fuel from the inner nozzle holes 23 may decrease. However, in this embodiment, the pressure of fuel is made to increase from T8, the decrease in the injection rate is suppressed. Then, because the outer needle 6 and the inner needle 7 begin to drop earlier than in the conventional art, the point in time T11 at which the injection rate becomes zero according to this embodiment comes before the point in time T13 at which the injection rate becomes zero in the conventional art. For this reason, in this embodiment, the period of fuel injection can be shortened, even in cases where the same amount of fuel as in the conventional art is injected. Then, if the period of fuel injection is shortened as in this embodiment, combustion can be suppressed from being carried out in a state where the mixing of fuel and air is insufficient, thus making it possible to decrease the generation of smoke. In addition, by increasing the pressure of fuel, atomization of fuel can be attained, whereby the generation of smoke can also be decreased. Moreover, due to improvement of the fuel state, it is also possible to improve fuel economy.

However, the period of fuel injection can be shortened by increasing the pressure of fuel from the start of fuel injection, too. But, when the injection rate of fuel is high at the time of the start of fuel injection, rapid combustion may take place, thus giving rise to a fear that noise may be generated. In addition, the combustion temperature may become too high, and the amount of discharge of NOx may increase. In contrast to this, by injecting fuel at a relatively low pressure at the time of the start of fuel injection start, as in this embodiment, the generation of noise can be suppressed, and the generation of NOx can also be suppressed.

### Second Embodiment

In this second embodiment, when the pressure of fuel is increased by the booster unit 4, the booster unit 4 is controlled so that the injection rate becomes constant. For that reason, the booster unit 4 according to this embodiment is assumed to be able to adjust the pressure of fuel in an arbitrary manner. The other components and so on in this second embodiment are the same as those in the first embodiment, so the explanation thereof is omitted.

The booster unit 4 according to the above-mentioned first embodiment boosts the pressure of fuel at a predetermined ratio, but does not carry out control according to the pressure of fuel. Because the pressure of fuel may change with the operating state of the internal combustion engine, in the case of increasing the pressure of fuel by the predetermined ratio, there is a fear that the injection rate may change before and after the fuel is boosted by means of the booster unit 4. When the injection rate changes, there is a fear that the fluctuation of torque may occur. In this second embodiment, an amount of increase in the pressure of fuel in which the injection rate becomes constant is calculated, and the booster unit 4 is driven so as to obtain the amount of increase in the pressure of fuel thus calculated.

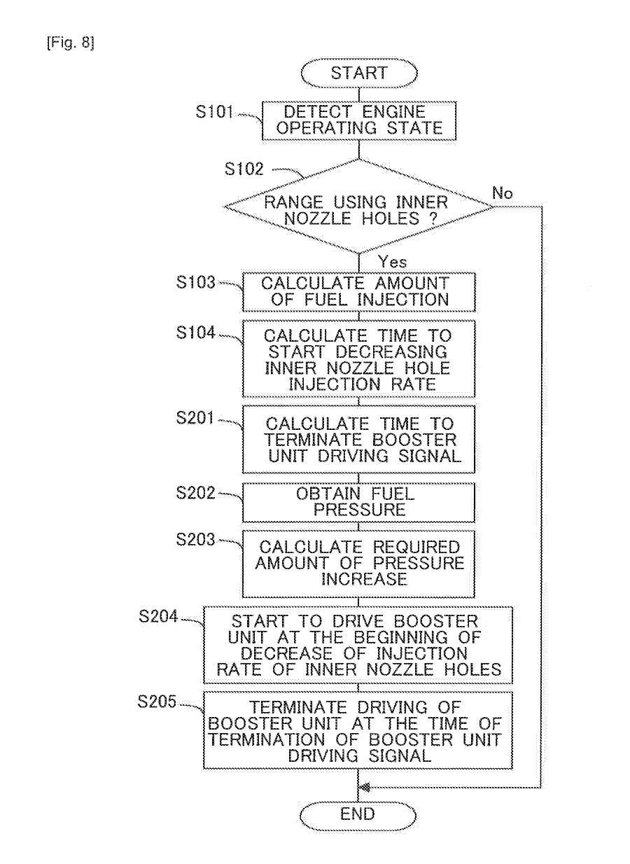

FIG. 8 is a flow chart showing a control flow or routine of the booster unit 4 according to this second embodiment. The routine in this flow chart is carried out by means of the ECU 10 at each combustion cycle. Here, note that the control of the outer needle 6 and the inner needle 7 is separately carried out by the ECU 10. For those steps in which the same processings as in the aforementioned flow chart in FIG. 5 are carried out, the same symbols are attached and the explanation thereof is omitted. In this second embodiment, the ECU 10, which carries out the routine in the flow chart shown in FIG. 8, corresponds to the controller in the present invention.

In the flow chart or routine shown in FIG. 8, when the processing of step S104 is terminated, the routine goes to step S201. In step S201, the time or timing to terminate the input of the driving signal to the booster unit 4 is calculated. For example, the time or timing to terminate the input of the driving signal to the booster unit 4 may be decided in such a manner that the cross-sectional area of the passage for fuel between the outer needle 6 and the valve seat 26 becomes equal to the cross-sectional area of the outer nozzle holes 22, when the pressure of increase becomes 0. In place of this, the point in time at which the outer needle 6 is seated on the valve seat 26 may be used as the time or timing to terminate the input of the driving signal to the booster unit 4, or the time or timing to terminate the input of the driving signal to the booster unit 4 may be decided in such a manner that the pressure of increase becomes 0 at the point in time at which the outer needle 6 is seated on the valve seat 26. Moreover, an optimum time or timing to terminate the input of the driving signal to the booster unit 4 may have been obtained by experiments, simulations, or the like in advance, in association with the operating state of the internal combustion engine. The relation between the amount of fuel injection and the time to terminate the input of the driving signal to the booster unit 4 may have been mapped and stored in the ECU 10.

In step S202, the pressure of fuel is obtained. This pressure of fuel is a pressure of fuel at the time when the increase in the pressure of fuel by the booster unit 4 is not carried out, and is a pressure of fuel in the period of time from T9 to T10 in FIG. 4. In this step, the pressure of fuel before being boosted by the booster unit 4 is obtained. Because this pressure of fuel is in correlation with the operating state of the internal combustion engine, the pressure of fuel can be obtained based on the operating state of the internal combustion engine. Here, note that the relation between the operating state of the internal combustion engine and the pressure of fuel has been obtained in advance through experiments, etc., and has been stored in the ECU 10.

In step S203, a required amount of pressure increase is calculated. The required amount of pressure increase is an amount of increase in the pressure of fuel at the time when the pressure of fuel is increased by the booster unit 4. In this step, the required amount of pressure increase is calculated in such a manner that an injection rate of fuel at the time when fuel is injected only from the outer nozzle holes 22 (i.e., an injection rate in the period of time from T9 to T10 in FIG. 4) becomes equal to an injection rate of fuel at the time when fuel is injected from both of the outer nozzle holes 22 and the inner nozzle holes 23 (i.e., an injection rate at T8 in FIG. 4). Here, the required amount of pressure increase is calculated based on the following relation.

$$DQ = CD \times A \times \sqrt{\frac{2 ( PCR - PA )}{D}} \qquad [ Math 1 ]$$

DQ is an injection rate of fuel at the point in time T8 in FIG. 4, and is in correlation with the operating state of the internal combustion engine, and hence, it is obtained based on the operating state of the internal combustion engine. The relation between the operating state of the internal combustion engine and DQ can be obtained by experiments, simulations, or the like in advance. CD is a flow rate coefficient, and has been obtained in advance. A is the cross-sectional area of the outer nozzle holes 22, and is obtained in advance. PCR is a fuel pressure after being boosted, and is a fuel pressure required in order to keep the injection rate constant. PA is a pressure of an atmosphere (a pressure in a combustion chamber) at the time of fuel injection, and can be estimated based on the operating state of the internal combustion engine, but it is sufficiently small as compared with the fuel pressure PCR, and hence, in this embodiment, it is set to 0. D is a density of fuel, and has been obtained in advance as an assumed density of fuel. The fuel pressure PCR can be calculated based on this expression. The required amount of pressure increase is calculated by subtracting from this fuel pressure PCR the fuel pressure obtained in step S202.

In step S204, the driving signal is inputted to the booster unit 4, after waiting until the time or timing calculated in step S104. That is, the driving of the booster unit 4 is started at the time or timing (T8) at which the injection rate of fuel from the inner nozzle holes 23 begins to decrease. The time or timing (T8) at which the injection rate of fuel from the inner nozzle holes 23 begins to decrease can be learned by counting or measuring a period of time elapsed from the starting point in time of the input of the injection signal, for example, by means of a timer. At this time, the booster unit 4 is controlled so that the pressure of fuel becomes higher by the required amount of pressure increase.

In step S205, the input of the driving signal to the booster unit 4 is terminated, after waiting until the time or timing calculated in step S201. The time or timing to terminate the input of the driving signal to the booster unit 4 can be learned by counting or measuring a period of time elapsed from the starting point in time of the input of the injection signal, for example, by means of a timer.

Here, note that in the flow chart shown in FIG. 8, the pressure of fuel is increased by the required amount of pressure increase calculated in step S203 to make, and hence, the control using a detected value by the pressure sensor 19 is not carried out. That is, when fuel is injected only from the outer nozzle holes 22, the pressure of fuel is increased by the required amount of pressure increase which has been obtained in advance. Instead of this, in this embodiment, up to the step S205, the pressure of fuel may also be controlled in a feedback manner so that the injection rate of fuel becomes constant. That is, the booster unit 4 may be controlled so that the pressure detected by the pressure sensor 19 becomes the fuel pressure PCR calculated in step S203.

As described above, according to this second embodiment, during the time when the inner needle 7 drops, the injection rate can be suppressed from changing, thus making it possible to suppress the fluctuation of torque from occurring.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

1 fuel injection valve
2 nozzle unit
3 back pressure unit
4 booster unit
6 outer needle
7 inner needle
10 ECU
17 accelerator opening sensor
18 crank position sensor
19 pressure sensor
21 nozzle body
22 outer nozzle holes
23 inner nozzle holes
26 valve seat
31 back pressure chamber
32 nozzle chamber
63 groove
73 protrusion

1. A fuel injection apparatus comprising:
a fuel injection valve that has a total nozzle hole area which becomes larger when an operation amount of a needle is large than when it is small; and
a controller comprising at least one processor configured to increase the pressure of fuel, upon a change of said total nozzle hole area from a large state to a small state, in such a manner that the pressure of fuel becomes larger when said total nozzle hole area is in the small state than when it is in the large state;
wherein said fuel injection valve has a first nozzle hole, a second nozzle hole, a first needle for opening and closing said first nozzle hole, and a second needle for opening and closing said second nozzle hole, said second needle being operable to lift with said first needle when an amount of lift of said first needle is equal to or more than a first predetermined amount;
said fuel injection apparatus further comprising: a pressure changer configured to change the pressure of fuel to be injected from said fuel injection valve;
wherein said controller further comprising at least one processor configured to increase the pressure of fuel by means of said pressure changer, when said first needle and said second needle drop so that the amount of lift of said second needle becomes a second predetermined amount, after the amount of lift of said first needle becomes equal to or more than said first predetermined amount.

2. The fuel injection apparatus as set forth in claim 1, wherein said second predetermined amount is an amount of lift at which the injection rate of fuel to be injected from said second nozzle hole decreases, if the pressure of fuel is not increased.

3. The fuel injection apparatus as set forth in claim 2, wherein said controller further comprising at least one processor configured to increase the pressure of fuel by means of said pressure changer so as not to change a combined injection rate of fuel, which is the sum of the injection rates of said first nozzle hole and said second nozzle hole, when said first needle and said second needle drop so that the amount of lift of said second needle becomes said second predetermined amount, after the amount of lift of said first needle becomes equal to or more than said first predetermined amount.
